(19) United States
(12) Patent Application Publication
(10) Pub. No.: US 2007/0041133 A1
(43) Pub. Date: Feb. 22, 2007

(54) Switch mode power supply apparatus with multiple regulated outputs and a single feedback loop

(76) Inventor: Hubertus Cornelis Miermans, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/557,643

(22) PCT Filed: May 13, 2004
(86) PCT No.: PCT/IB04/50681

§ 371 Date: Nov. 17, 2005

(30) Foreign Application Priority Data
May 21, 2003 (EP) 03101449.1

(51) Int. Cl. H02H 9/00

(52) U.S. Cl. 361/18

(57) ABSTRACT

There is provided a switch mode power supply apparatus (200) for receiving an input supply voltage (V1) from an input supply source (20) and generating a corresponding main regulated output supply voltage (V2) and at least one subsidiary output supply voltage (V4). The apparatus (200) includes: (a) an inductive structure (TR₁) having a terminal for providing a secondary output (NS 1); (b) a switching structure (SW1) coupled between the input supply source (20) and the inductive structure (TR1) for applying current to the inductive structure (TR,) in a switched manner, (c) a main rectifying structure (D, C1) for receiving the secondary output (NS2) and generating the main regulated output supply voltage (V2) therefrom; (d) a feedback structure (AMP,) for comparing the main regulated output supply voltage (V2) with at least one reference (30) to adjust operation of the switching structure (SW) so as to maintain the main output supply voltage (V₂) in regulation; and (e) a subsidiary rectifying structure (210) comprising a voltage multiplier comprising a capacitor (C3) coupled to the terminal of the inductive structure (TR,) so as to receive signals therefrom which are subject to regulation by the feedback structure (AMP,) for generating the at least one subsidiary output voltage (V4).

### FIELD OF THE INVENTION

The present invention relates to switch mode power supply apparatus (SMPS); in particular, but not exclusively, the invention relates to SMPS providing multiple regulated outputs whilst employing only a single feedback loop for providing such regulation.

### BACKGROUND TO THE INVENTION

Switch mode power supply apparatus (SMPS) are widely known and employed in diverse applications such as computers, consumer electronic equipment, battery chargers to mention a few. When configured to receive an alternating current (a.c.) mains supply and deliver a regulated direct current (d.c.) output, the SMPS usually include a transformer whose primary winding is coupled via a switching arrangement to the rectified a.c. mains supply, a secondary winding coupled via a rectification arrangement to a charge storage arrangement across which the regulated d.c. output is generated, and a feedback arrangement coupled to the charge storage arrangement and to the switching arrangement for controlling operation of the switching arrangement so as to regulate the d.c. output to a desired potential.

On account of their widespread use, numerous alternative circuit configurations for SMPS are known. For example, SMPS circuit configurations are describe in published U.S. Pat. Nos. 4,517,633, 5,835,360 and in a published United States patent application no. US 2001/0028570.

In the aforesaid U.S. Pat. No. 5,835,360, there is described a SMPS including two output circuits, one of which is directly regulated by control of an input switching device of the SMPS and the other of which is indirectly regulated. Such indirect regulation is provided by way of an additional winding wound in common around an energy-storing magnetic core comprising windings of the first and second output circuits. The additional winding is connected between a relatively lower-voltage one of the output circuits and the other relatively higher-voltage output circuit. Moreover, the additional winding is connected such that a linking current is capable of flowing therethrough from the higher-voltage output to the lower-voltage output when the lower-voltage circuit is lightly loaded; the linking current is susceptible to decreasing as loading on the lower-voltage output increases. By utilizing three windings wound around the magnetic core, a greater degree of common magnetic coupling is achievable resulting in an enhanced degree of regulation of the outputs in operation.

In order to juxtapose the present invention in context, known contemporary configurations for SMPS will be described with reference to FIGS. 1 and 2. In FIG. 1, a simple fly-back SMPS is indicated generally by 10 and comprises a transformer TR₁, a switching device SW₁, a feedback control amplifier AMP₁, a rectifier diode D₁, an electrolytic reservoir capacitor C₁ and a voltage reference 30 for providing a reference voltage V₃. The amplifier AMP₁ includes an analogue control amplifier, a saw-tooth oscillator and an analogue comparator (not shown); the analogue amplifier is configured to receive inverting (−) and non-inverting (+) input signals and provide an amplified analogue output signal corresponding to an amplified difference between these inverting and non-inverting input signals, the sawtooth generator is arranged to generate an analogue sawtooth waveform signal, and the comparator is arranged to receive the amplified output signal and the sawtooth signal and compare them to generate a rectangular wave output signal whose mark-space ratio is variable in response to the potential of the sawtooth waveform relative to that of the analogue output signal, the rectangular output waveform being suitable for driving the switching device SW₁. The transformer TR₁ includes primary and secondary windings NP₁, NS₁ respectively which are magnetically coupled on a common core. The secondary winding NS₂ is connected through the diode D₁ to the capacitor C₁ connected in parallel with an electrical load LD₁ across which an output voltage V₂ is developed in operation. The primary winding NP₁ is coupled via power terminals of the switching device SW₁ to an input power source 20 providing in operation a potential V₁ thereacross. The SMPS 10 is thus connected together as illustrated in FIG. 1. The source 20 is optionally connected to a ground potential GND when the transformer TR₁ is not utilized to provide isolation.

In operation, the device SW₁ repetitively conducts a current Iₛ therethrough for a conduction periods t₁ (see inset graph showing waveforms as function of time t), between which the device SW₁ is substantially non-conducting for non-conduction periods t₂. When the device SW₁ conducts in the conduction period t₁, the current Iₛ increases substantially linearly therethrough to assume a value iₚ at the end of the conduction period t₁ according to Equation 1 (Eq. 1):

$${i}_{p} = \frac{{V}_{1} {t}_{1}}{{L}_{p}} \qquad Eq . 1$$

wherein Lₚ is the inductance exhibited in operation at connection terminals of the primary winding NP₁.

The current Iₛ is operable to repetitively establish a magnetic field within the core of the transformer TR₁. At the end of each conduction period t₁, the magnetic field established in the core collapses to generate a back electro-motive force (e.m.f.) which attempts to maintain the current Iₛ flowing in the primary winding NP₁ but, because the device SW₁ is non-conducting during the non-conduction period t₂, results in a current flowing in the secondary winding NS₁ to cause charge to be delivered to the capacitor C₁ via the diode D₁. The amplifier AMP₁ is operable to monitor the output voltage V₂ developed across the load LD₁ and compare it with the reference voltage V₃, the amplifier AMP₁ modifying one or more of the duration of the conduction period t₁ and the non-conduction period t₂, for example by way of PWM control, so as to try to force by negative feedback a difference between the voltages V₂ and V₃ towards zero magnitude.

It is known in the art that situations are encountered in cost-sensitive applications where the SMPS 10 beneficially includes a second output without incurring the cost of two control amplifiers and associated regulating electronic devices. In order to achieve such a compromise between functionality and cost, it is customary to modify the SMPS 10 in FIG. 1 into a corresponding SMPS indicated generally by 100 in FIG. 2.

In the SMPS 100, there is included a transformer TR₂ which is similar to the transformer TR₁ except that a second secondary winding NS₂ is included on the transformer TR₂ in addition to the first secondary winding NS₁. The secondary winding is coupled to an additional secondary circuit including a diode D₃ and a reservoir capacitor C₂ coupled across a second load LD₂, the additional secondary circuit being operable to develop an output voltage V₄ across the load LD₂. The secondary winding NS₂ is connected in series with the first winding NS₁ as illustrated in FIG. 2.

Theoretically, the output voltage V4 is related to the voltage V2 by Equation 2 Eq. 2):

$${V}_{4} = {V}_{2} ( \frac{{n}_{NS 2} + {n}_{NS 1}}{{n}_{NS 1}} ) \qquad Eq . 2$$

wherein n_{NS1} and n_{NS2} are the number of turns on the first and second secondary windings NS₁, NS₂ respectively.

In an ideal situation, the amplifier AMP₁ is operable to regulate the voltages V₂ and V₄ perfectly when the windings NP₁, NS₁ and NS₂ are closely magnetically coupled. However, the inventor has appreciated that imperfect coupling is experienced in practice on account of flux leakage in the transformer TR₂, such imperfect coupling resulting in the voltage output V₄ appearing to result from a source with a relatively higher internal resistance than for the voltage output V₂. Thus, without perfect coupling in the transformer TR₂, the voltage output V₄ is imperfectly regulated.

The inventor has experimentally characterised the SMPS 100 in FIG. 2 where the transformer TR2 incorporates aluminium foil windings. The practical implementation of the SMPS 100 exhibited a measured performance as provided in FIG. 3, showing the output voltage V₄ as function of the current I_{LD2} through the second LD₂. The SMPS 100 was implemented with similar number of turns n_{NS1}, n_{NS2} on the first and second windings NS₁, NS₂ respectively, and regulated so as to output V₂=5.2 volts for the load LD₁ drawing 0 Amps (curve K1), 2 Amps (curve K2), 4 Amps (curve K3) and 8 Amps (curve K4). Whereas operation for the load LD₁ drawing in a range of 2 to 8 Amps and the load LD₂ drawing in excess of 0.1 Amps is potentially acceptable in certain non-critical applications, the inventor has appreciated that performance of the SMPS 100 is unsatisfactory for many applications where circuit cost and complexity need to be reduced as much as possible and yet high quality regulation is required.

The inventor has appreciated that regulation performance of the SMPS 100 is improved by employing foil windings on the transformer TR₁, for example aluminium and/or copper foil windings. However, such foil wound transformers are expensive to manufacture and require specialist manufacturing skills in comparison to conventional winding techniques employed for enamelled copper wire. Often such foil-wound magnetic components are expensive single-sourced items.

Conventional windings, for example enamelled copper wire windings, used in the transformer TR₂ result in a degraded SMPS performance in comparison to that presented in FIG. 3. In order to ameliorate performance of the SMPS 100 implemented with such enamelled copper wire windings, the inventor has appreciated that the windings can be interleaved and/or arranged in a bifilar configuration and/or wound in other spatial winding configurations to improve regulation of the second output V₂. However, such special transformer implementations are only capable in practice of reducing cross-regulation errors in the SMPS 100 to a range of 5 to 10% for moderate load current changes. Such performance in many technical applications is not satisfactory.

As described in the foregoing, more precise regulation of the second secondary output V₂ is feasible using active electronic devices, for example by including linear and/or switch mode regulator devices between the capacitor C₂ and the load LD₂, but is prohibitively expensive and/or too complex a solution and/or insufficiently power efficient for many practical applications where SMPS are required.

The inventor has therefore devised a SMPS configuration which at least partially addresses the aforesaid problem of regulation with regard to one or more additional SMPS secondary outputs without there being a need to employ specially-wound transformers and/or additional output regulation devices.

### SUMMARY OF THE INVENTION

A first object of the present invention is to provide a switch mode power supply apparatus (SMPS) including a first regulated output and at least one subsidiary output which are regulated to greater accuracy without substantially increasing circuit complexity and cost. The invention is defined by the independent claim. The dependent claims define advantageous embodiments.

The apparatus is of advantage in that it is capable of providing at least one subsidiary output supply which is more accurately regulated relative to the main output supply. The inductive means may be a transformer or an inductor.

Preferably, in the apparatus, the inductive means and the main rectifying means are configured as a flyback-type converter switch mode power supply. A flyback-type converter switch mode power supply is one which includes a transformer-type component in the inductive means whose magnetic field in operation is arranged to periodically reduce to cause a flyback potential to be generated for use in generating the output supplies from the apparatus. Flyback-type converter SMPS are known to be highly efficient and capable of providing isolation between the input the input supply and the output supply, for example as in isolating mains electricity supplies.

Alternatively, an apparatus is arranged such that the inductive means and the main rectifying means are configured as a buck-type converter switch mode power supply. A buck-type converter switch mode power supply is one where current delivered to its load is passed through an inductive component, the current being subjected to periodic interruption for control of power to the load. Buck-type converter SMPS are of advantage in that they are relatively simple and yet can be arranged to handle considerable power.

In the apparatus, the main rectifying means and the subsidiary rectifying means are preferably mutually connected in such a manner that voltage drops in the respective rectifying means are arranged to at least partially cancel so as to render the at least one subsidiary output supply voltage less dependent upon the voltage drops. An at least partial compensation of the voltage drops provides an enhanced regulation stability of the at least one subsidiary output supply voltage.

More preferably, diodes included within the main rectifying means and the subsidiary rectifying means for current rectification purposes comprise at least one of Silicon, Germanium and Schottky diodes. Germanium and Schottky diodes are of advantage in that they exhibit lower forward conduction voltage drops thereacross in comparison to silicon diodes; however, silicon diodes are relatively inexpensive and robust, especially when high reverse potential thereacross are encountered in operation. Alternatively, diodes included within the main rectifying means and the subsidiary rectifying means for current rectification purposes comprise switching devices functioning as synchronous rectifiers; such synchronous rectification is potentially capable of being more energy efficient than using silicon diodes.

Preferably, the apparatus is configured such that the main output supply voltage and the at least one subsidiary supply voltage are arranged to be substantially symmetrical positive and negative voltages.

Preferably, the subsidiary rectifying means is devoid of active regulation components. Such an arrangement is capable of reducing manufacturing cost and complexity of the apparatus.

Preferably, the subsidiary rectifying means comprise an inductor, and a diode. Such components are relatively straightforward to procure from multiple sources, are potentially robust and are potentially inexpensive. The inductor is preferably not magnetically coupled to the inductive means.

Preferably, in the apparatus, at least one of the main rectifying means and the subsidiary rectifying means includes its rectifying diode in a return path for current. When designing certain types of equipment, it is occasionally convenient to include rectifier diodes in return paths on account of electrical characteristics of other electronic components configured around the apparatus.

Preferably, in the apparatus, the subsidiary rectifying means includes a low pass filter preceding its at least one subsidiary output supply voltage for attenuating switching ripple of the at least one subsidiary output voltage. Such a filter is capable of reducing ripple of the at least one subsidiary output supply voltage and thereby enable, for example, a relatively lower switching frequency to be employed.

Conveniently, to obtain best regulation in the apparatus, the main rectifying means and the subsidiary rectifying means are arranged to generate the main output supply voltage and the at least one subsidiary output supply voltage to be mutually integer multiples of one another.

Alternatively, to suit the requirements of some users, the main rectifying means and the subsidiary rectifying means are arranged to generate the main output supply voltage and the at least one subsidiary output supply voltage to be mutually non-integer multiples of one another.

### DESCRIPTION OF THE DRAWINGS

Embodiments of the invention will now be described, by way of example only, with reference to the following diagrams, wherein:

FIG. 1 is a schematic circuit diagram of a contemporary switch mode power supply apparatus (SMPS) providing a single regulated output;

FIG. 2 is a schematic circuit diagram of a contemporary SMPS providing a single regulated output and an additional unregulated output;

FIG. 3 is a graph illustrating measured performance of the SMPS of FIG. 2 when implemented using a transformer with conductive foil windings;

FIG. 4 is a schematic diagram of a first flyback-type converter switch mode power supply apparatus (SMPS) according to the invention, the first SMPS including a main regulated output and an additional positive polarity output;

FIG. 5 is a graph illustrating measured performance of the SMPS of FIG. 4 when implemented using a transformer with conductive foil windings;

FIG. 6 is a signal versus time graph illustrating switching operation of the first SMPS of FIG. 4;

FIG. 7 is a schematic diagram of a second flyback-type converter switch mode power supply apparatus (SMPS) according to the invention, the second SMPS including a plurality of additional positive polarity outputs;

FIG. 8 is a schematic diagram of a third flyback-type converter switch mode power supply apparatus (SMPS) according to the invention, the third SMPS operable to provide an additional positive polarity output and including a diode configured in a return path;

FIG. 9 is a schematic diagram of a fourth flyback-type converter switch mode power supply apparatus (SMPS) according to the invention, the fourth SMPS being a variant of the first SMPS of FIG. 4 arranged to provide an additional negative polarity output;

FIG. 10 is a schematic diagram of a fifth flyback-type converter switch mode power supply apparatus (SMPS) according to the invention, the fifth SMPS being a variant of the third SMPS of FIG. 8 and arranged to provide an additional negative polarity output and including a diode configured in a return path;

FIG. 11 is a schematic diagram of a contemporary buck-type converter switch mode power supply apparatus (SMPS);

FIG. 12 is a schematic diagram of a sixth buck-type converter switch mode power supply apparatus (SMPS) according to the invention, the sixth SMPS arranged to provide an additional positive polarity output;

FIG. 13 is a schematic diagram of a seventh buck-type converter switch mode power supply apparatus (SMPS) according to the invention, the seventh SMPS being a variant of the sixth SMPS and arranged to provide an additional negative polarity output;

FIG. 14 is a schematic diagram of a contemporary forward-type converter switch mode power supply apparatus (SMPS);

FIG. 15 is a schematic diagram of an eighth forward-type converter switch mode power supply apparatus (SMPS) according to the invention, the eighth SMPS arranged to provide an additional positive polarity output;

FIG. 16 is a schematic diagram of a ninth forward-type converter switch mode power supply apparatus (SMPS) according to the invention, the ninth SMPS arranged to provide an additional negative polarity output, and

FIG. 17 is a schematic diagram of a tenth flyback-type switch mode power supply apparatus (SMPS) according to the invention, the tenth SMPS being a variant of the first SMPS arranged to provide an additional output potential which is a non-integer multiple of a main output from the tenth SMPS.

If references in a FIG. are not described, they refer to the same signals or the same elements performing the same function in a preceding FIG.

### DESCRIPTION OF EMBODIMENTS OF THE INVENTION

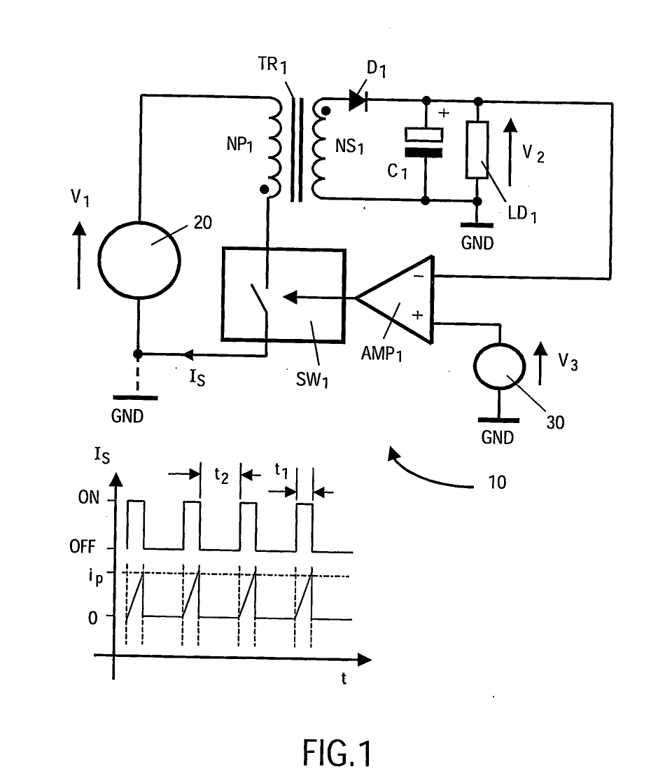

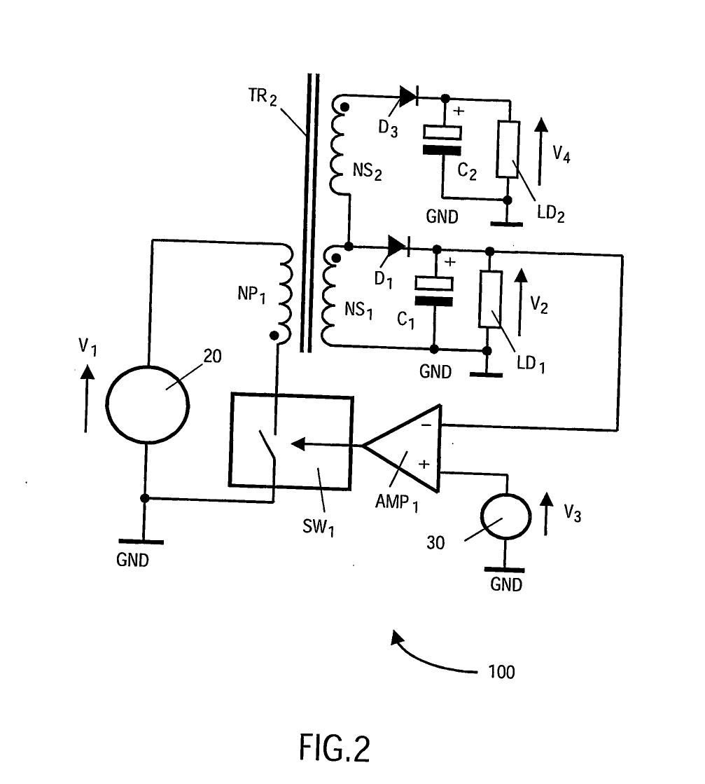

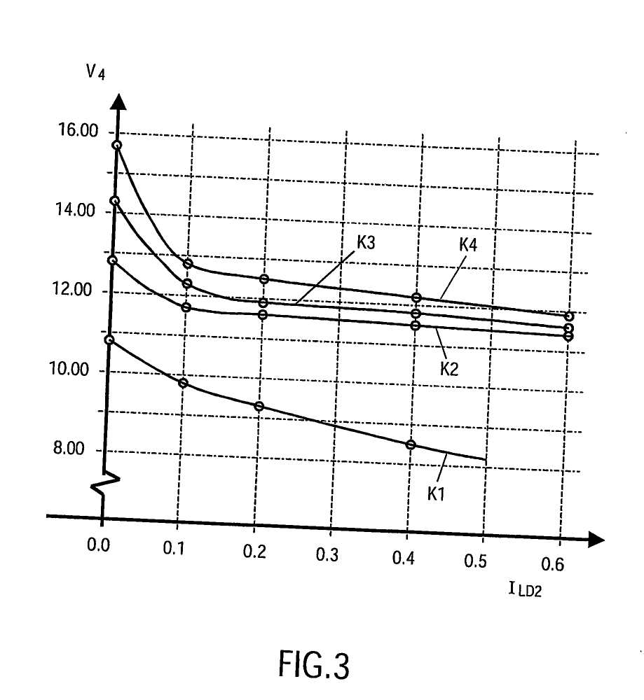

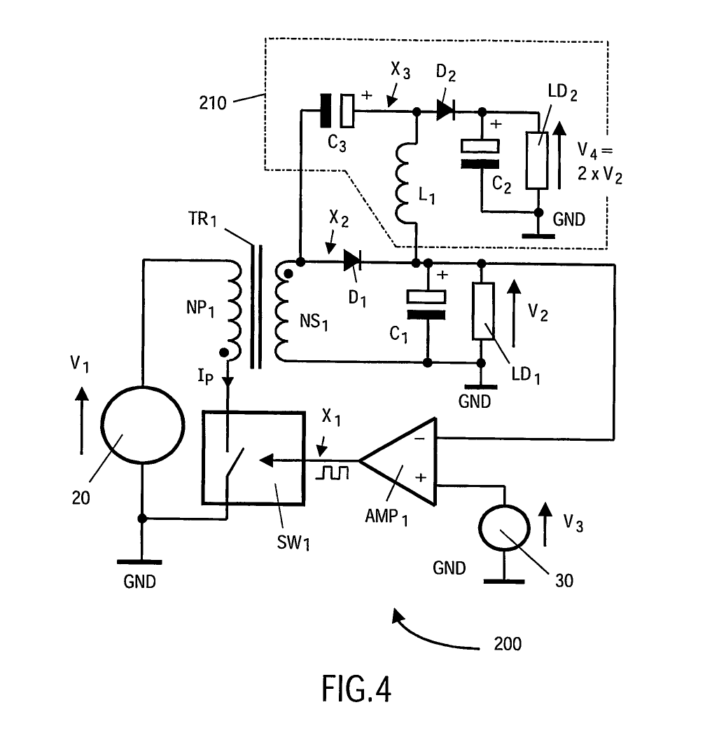

As described in the foregoing, the inventor has appreciated that an aforementioned contemporary flyback-mode switch mode power supply apparatus (SMPS) 100 illustrated in FIG. 2 provides an unsatisfactory quality of regulation at its additional output designated by V₄; such unsatisfactory regulation is illustrated graphically in FIG. 3. Whereas the inventor has appreciated that the SMPS 100 is a conventional logical development from an aforementioned SMPS 10 illustrated in FIG. 1, the inventor has devised an alternative first flyback-type converter switch mode power supply apparatus (SMPS) according to the invention, the SMPS indicated generally by 200 in FIG. 4.

The SMPS 200 includes an aforementioned transformer TR₁ as employed in the contemporary SMPS 10 together with its associated switching device SW₁, its feedback control amplifier AMP₁ and its voltage reference 30. An aforementioned primary winding NP₁ of the transformer TR₁ is connected at its first terminal to a first terminal of a power source 20 sustaining an output voltage of a magnitude V₁ relative to a ground potential GND; moreover, a second terminal of the primary winding NP₁ is connected via power terminals of the switching device SW₁ to the ground potential GND. Furthermore, the SMPS 200 also includes an aforementioned diode D₁ connected from its anode terminal to a first terminal of an aforementioned secondary winding NS₁ of the transformer TR₁; moreover, the diode D₁ is connected at its cathode terminal to a positive electrode of an aforementioned electrolytic reservoir capacitor C₁ as shown; a second terminal of the secondary winding NS₁ and a negative electrode of the capacitor C₁ are also connected to the ground potential GND as illustrated. An aforementioned first load LD₁ is coupled across the capacitor C₁ as shown. A feedback connection is coupled from the positive electrode of the capacitor C₁ to an inverting input (−) of the amplifier AMP₁ as illustrated. Moreover, an aforementioned reference voltage V₃ from the reference 30 is coupled to a non-inverting input (+) of the amplifier AMP₁. The amplifier AMP₁ is arranged in operation to provide a switching output signal X₁ whose pulse width ratio and/or pulse repetition frequency are a function of a voltage difference arising between signals applied to the inverting (−) and non-inverting (+) inputs of the amplifier AMP₁. As elucidated in the foregoing, the amplifier AMP₁ includes component parts for generating a pulse width modulated (PWM) output therefrom.

The SMPS 200 further includes a voltage doubling circuit shown included within dashed lines 210. The doubling circuit includes an electrolytic capacitor C₃ connected at its negative electrode to the first terminal of the secondary winding NS₁ designated by a black dot; moreover, the capacitor C₃ is connected at its positive electrode to an anode electrode of an aforementioned diode D₂ and a first terminal of an inductor TR₁. The inductor TR₁ is not magnetically coupled, for example by winding thereonto, onto a magnetic core of the transformer TR₁; namely, the inductor TR₁ is substantially magnetically isolated from the magnetic core of the transformer TR₁. However, as described later, the inductor TR₁ can be arranged to be at least partially magnetically coupled to the transformer TR₁ if required. A second terminal of the inductor TR₁ is connected to the cathode electrode of the diode D₁ as illustrated. A cathode electrode of the diode D₂ is connected to a positive electrode of an aforementioned reservoir capacitor C₂ whose negative electrode is connected to the ground potential GND. An aforementioned second load LD₂ is connected across the electrodes of the capacitor C₂.

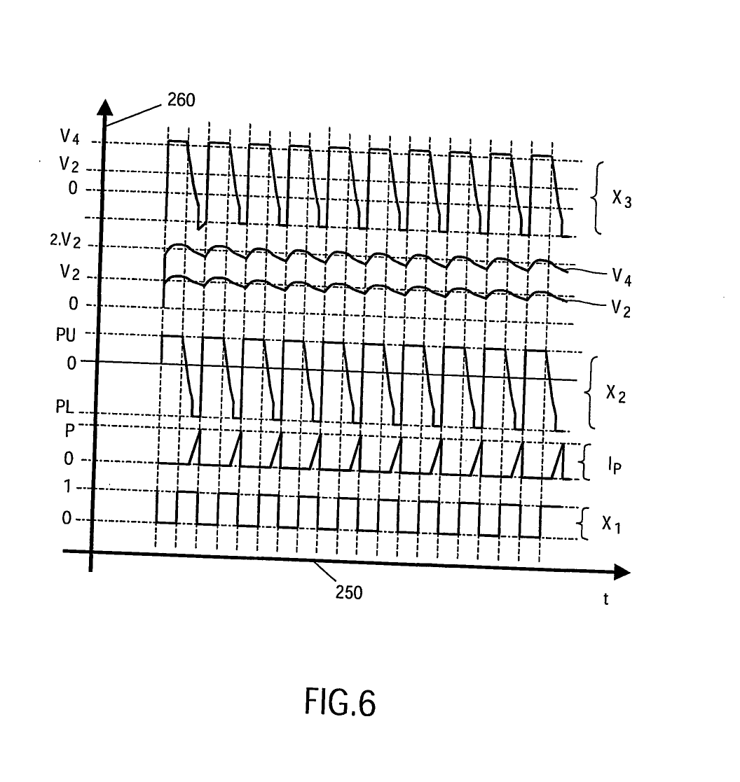

In order to elucidate operation of the SMPS 200, quasi-constant (d.c.) conditions of the SMPS 200 will firstly be considered. In operation, an average potential developed across the secondary winding NS₁ is substantially zero because this winding NS₁ is inductively coupled to the primary winding NP₁; namely, a signal X₂ averages to substantially the ground potential GND as illustrated in FIG. 6. In FIG. 6, an abscissa axis 250 represents time and an ordinate axis 260 represents signal magnitude. Similarly, assuming the inductor TR₁ has negligible resistance, an average potential developed thereacross averages substantially to zero; namely, a signal X₃ averages to a potential V₂ developed across the load LD₁ on average. In consequence, an average potential developed across the capacitor C₃ is equivalent to the potential V₂ developed across the load LD₁.

In momentary (a.c.) conditions, the signal X₂ fluctuates in a manner as illustrated also in FIG. 6; namely, the signal X₂ peaks momentarily at a magnitude PU according to Equation 3 (Eq. 3):
PU=V₂+V_{D1} Eq. 3
wherein a potential V_{D1} is a forward-conduction voltage drop arising across the diode D₁; for example, V_{D1} is substantially 0.7 volts when the diode D₁ is a Silicon device, although lower magnitudes of the voltage drop V_{D1} are achievable using Schottky diodes or Germanium diodes, for example in the order of 0.2 volts. When the switching device SW₁ is operated at a sufficiently high frequency such that a potential developed across the capacitor C₃ is quasi-constant in operation, for example a sufficiently high frequency to prevent momentary discharging of the capacitor C₃ through the inductor TR₁, the signal X₃ correspondingly momentarily peaks at a potential of (2×V₂)+V_{D1}. As the diode D₂ in conjunction with the capacitor C₂ are operable to charge the capacitor C₂ to a potential corresponding to the peak value of the signal X₃ less a forward-conduction voltage drop V_{D2} across the diode D₂, a potential V₄ developed across the load L_{D2} according to Equation 4 (Eq. 4):
V₄=(V₂+V_{D1})+(V₂−V_{D2}) Eq. 4

When the diodes D₁, D₂ are of mutually similar type, for example matched devices which are preferably isothermally coupled, Equation 4 simplifies to V₄=2×V₂. This example is shown in FIG. 6, wherein the potential V₄ is substantially equal to 2×V₂, apart from a relatively small ripple caused by charging and decharging of the capacitors C₁, C₂ and C₃. As the potential V₂ is regulated by action of the amplifier AMP₁ in relation to the reference voltage V₃, the potential V₄ is also accordingly substantially regulated.

With reference to FIG. 6, the signal X₁ is illustrated switching between logic states ‘0’ and ‘1’ corresponding to non-conduction and conduction respectively of the switching device SW₁ between its power electrodes. Correspondingly, a current Iₚ flowing through the switching device SW₁ assumes substantially a rising ramp form with P as peak value as illustrated, while the signal X₂ is negative to a magnitude −PL. When the switching device SW₁ is non-conducting, causing Iₚ to be substantially zero, an associated decay of magnetic field is established within the core of the transformer TR₁. The magnitude of −PL is determined by the magnitude of the input voltage V₁.

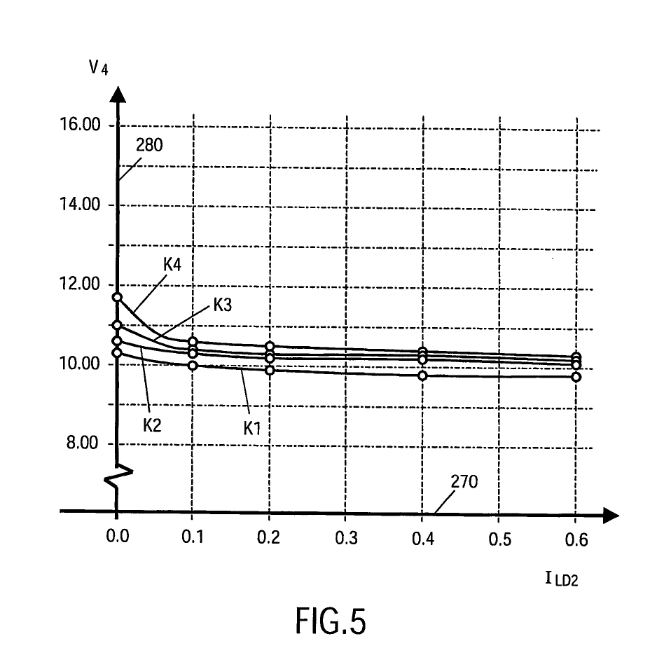

The inventor has constructed and experimentally characterised the SMPS 200 of FIG. 4 to yield results as illustrated in FIG. 5, wherein curves K4, K3, K2, K1 correspond to current flow through the load LD₁ of 8 Amps, 4 Amps, 2 Amps and 0 Amps respectively. An abscissa axis 270 of FIG. 5 corresponds to a current flow through the load LD₂, namely a current I_{LD2}; moreover, the potential V₄ is represented along a corresponding ordinate axis 280.

Regulation characteristics of the SMPS 200 with regard to the load LD₂ shown in FIG. 5 are to be compared with regulation characteristics of the SMPS 100 shown in FIG. 3. It will be observed that regulation characteristics of the SMPS 200 are far superior to those of the SMPS 100. Moreover, whereas the SMPS 100 employs the transformer TR₁ implemented using foil conductor technology, the SMPS 200 is capable of yielding performance results similar to those shown in FIG. 5 when its transformer is implemented using more conventional enamelled copper wire coil winding construction procedures. The SMPS 200 is capable of providing superior regulation even when substantially zero current is drawn by the load LD₁.

The SMPS 200 is distinguished from the SMPS 100 in that, although both include a primary regulated circuit for generating the voltage V₂ controlled by the amplifier AMP₁, the SMPS 200 derives its additional output V₄ by way of voltage multiplication derived directly from the primary circuit and subject to control of its amplifier AMP₁ whereas the SMPS 100 derives its additional output V₄ by way of indirect imperfect magnetic coupling such that the amplifier AMP₁ is not capable of providing precise regulation.

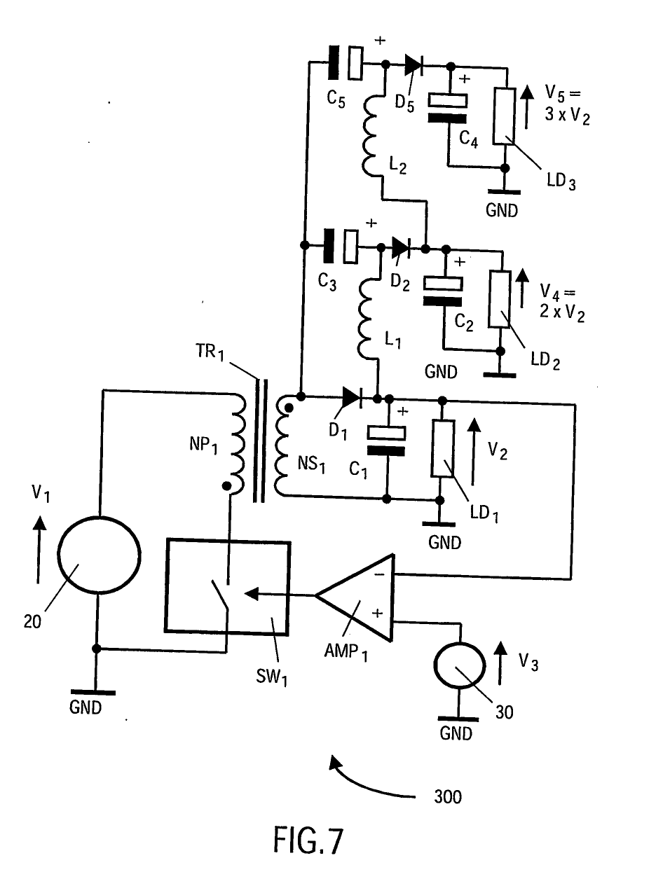

It will be appreciated that the SMPS 200 of FIG. 4 can be modified to provide more than a single additional output. For example, in FIG. 7, there is shown a modified version of the SMPS 200, the modified SMPS indicated generally by 300. Components shown included within the dashed lines 210 of FIG. 4 are multiply stacked in the SMPS 300 to provide two additional output voltages V₄, V₅; the voltages V₄, V₅ are substantially twice and thrice V₂ respectively. Preferably, the diodes D₁, D₂ and a further diode D₅ in the SMPS 300 are mutually similar; more preferably, they are mutually isothermal in operation. It will be appreciated that more than two additional outputs are susceptible to being added to the SMPS 300 in a similar manner, for example to generate an output which is a quadruple of the potential V₂.

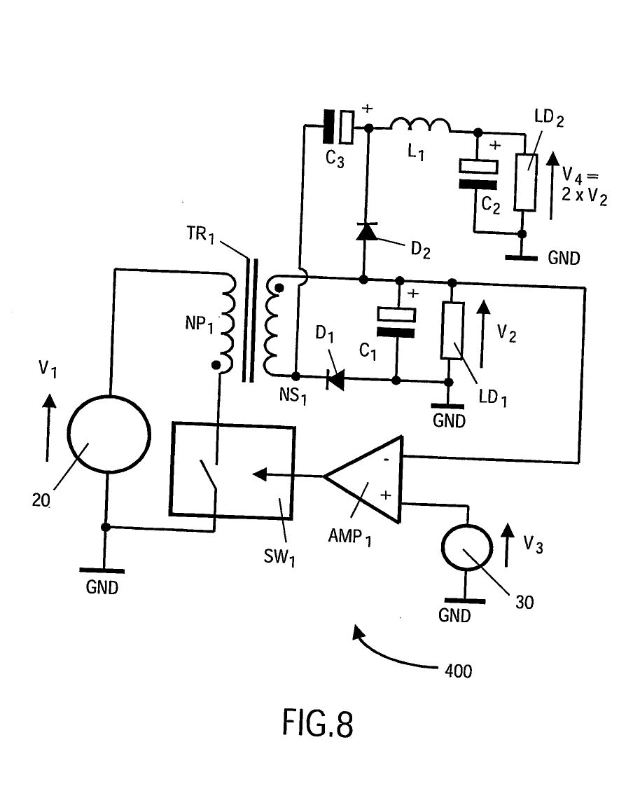

The SMPS 200 is capable of being implemented in several mutually different circuit topologies. For example, in FIG. 8, there is shown a SMPS indicated generally by 400 wherein the diode D₁ is connected in a return path from the load LD₁, and the inductor TR₁ is, connected between the capacitor C₃ and the load LD₂ with its associated reservoir capacitor C₂. Moreover, the diode D₂ is connected at its anode electrode to the capacitor C₁ and its cathode electrode to a junction where the capacitor C₃ and the inductor TR₁ are connected as illustrated. The SMPS 400 is of advantage in that the arrangement of the inductor TR₁ with the capacitor C₂ is capable of forming an effective low-pass filter for filtering out switching-frequency ripple arising across the capacitor C₃ in operation. The SMPS 400 is operable to provide two positive outputs at V₂ and twice V₂ (V₄).

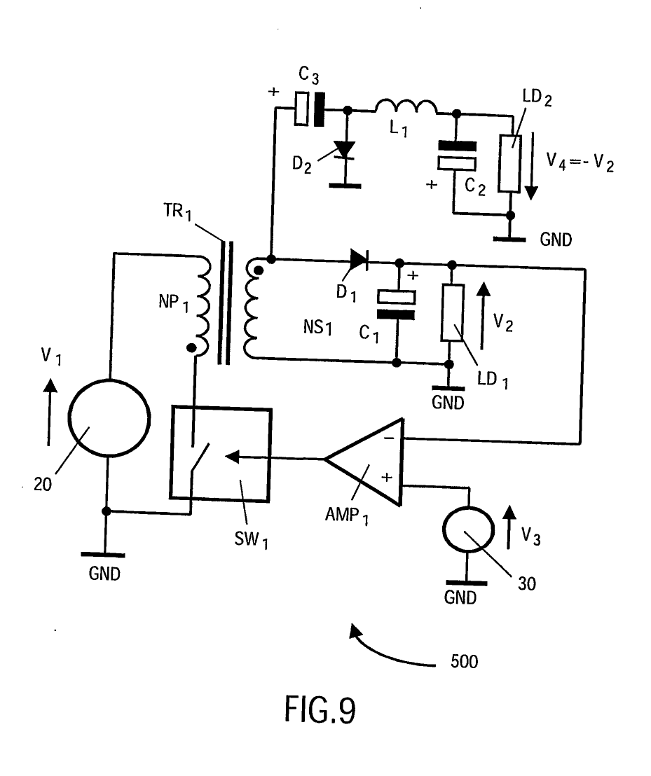

In many electronic systems, it is often desirable to have available symmetrical positive and negative supply potentials relative to ground potential, for example for providing power to analogue circuits such as operational amplifiers, analogue-to-digital (A/D) converters, digital-to-analogue (DAC) converters and audio amplifiers. Thus, in FIG. 9, there is shown a modified version of the SMPS 200, the modified SMPS being indicated generally by 500. The SMPS 500 is similar to the SMPS 200 except that, in the SMPS 500, the capacitor C₂ is inverted, the capacitor C₃ is connected at its negative electrode to an anode electrode of the diode D₂ and to a first terminal of the inductor TR₁. A second terminal of the inductor TR₁ is connected to the load LD₂. Moreover, a cathode electrode of the diode D₂ is connected to the ground potential (GND). The SMPS 500 is of advantage in that its positive and negative outputs connected to the loads LD₁, LD₂ respectively are mutually tracking with respect of the reference voltage V₃. Furthermore, the topological arrangement of the inductor TR₁ and the capacitor C₂ is capable of functioning as a low pass filter for effectively attenuating switching frequency ripple present across the capacitor C₃.

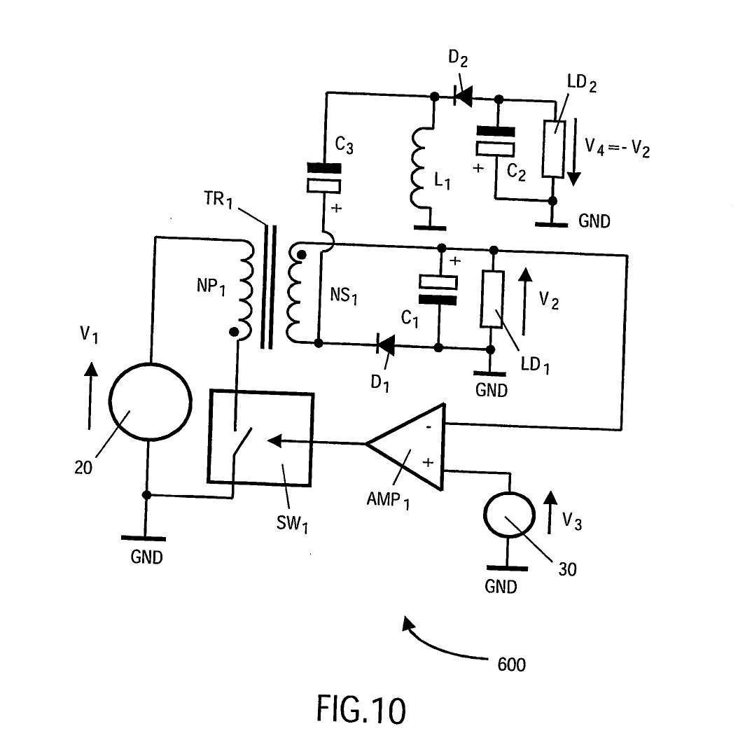

In FIG. 10, there is shown a further switch mode power supply apparatus (SMPS) indicated generally by 600. The SMPS 600 is similar to SMPS 500 in function in that it is capable of providing substantially symmetrical positive and negative outputs to the loads LD₁, LD₂ respectively. However, the diode D₁ is included in a return path as shown. Similarly, the diode D₂ is connected in a forward path to provide the negative polarity output to the load LD₂ as illustrated.

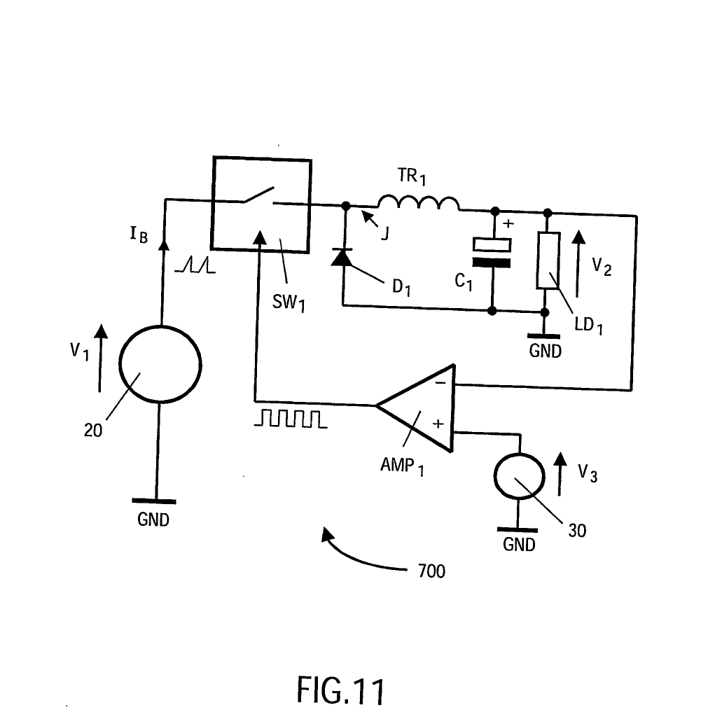

It will be appreciated that the present invention is not merely limited to various configurations of fly-back converter SMPSs. In order to provide additional outputs to buck-type converter switch mode power supplies (SMPSs) providing a main regulated output, one or more voltage multipliers directly linked to the main regulated output can be employed. In order to better elucidate the invention in this respect, a contemporary buck-type converter SMPS will now be described with reference to FIG. 11, the contemporary buck-type SMPS indicated generally by 700.

The SMPS 700 comprises the switching device SW₁ coupled at its first power electrode to the input supply 20 which is connected in turn to the ground potential GND. The device SW₁ is connected at its second power electrode to a cathode electrode of the diode D₁ and to a first terminal of the inductor TR₁. An anode electrode of the diode D₁ is connected to the ground potential GND. A second terminal of the inductor TR₁ is connected to a parallel combination of the load LD₁ connected in parallel with the capacitor C₁. Moreover, the second terminal of the inductor TR₁ is also connected to the inverting (−) input of the control amplifier AMP₁. The non-inverting input (+) of the amplifier AMP₁ is coupled to the reference voltage V₃. Moreover, a PWM and/or pulse repetition rate control output is coupled from the output of the amplifier AMP₁ to a switching input of the switching device SW₁.

In operation, a current I_{B} flows from the source 20 through the switching device SW₁, the inductor TR₁, the load LD1 and finally via the ground potential GND back to the source 20. The switching device SW₁ is driven by the control amplifier AMP₁ to interrupt the current I_{B} periodically. When the device SW₁ conducts, the current I_{B} increases in a ramp-like manner whilst establishing a magnetic field in the inductor TR₁. Immediately after each momentary conduction of the switching device SW₁, the magnetic field in the inductor TR₁ decreases forcing a terminal J of the inductor TR₁ momentarily to assume a potential corresponding to −V_{D1} where V_{D1} is a forward conduction voltage drop across the diode D₁. Moreover, energy stored within the magnetic field of the inductor TR₁ is thereby transferred to the capacitor C₁ and subsequently to the load L_{D1}.

The SMPS 700 is of benefit in that it enables a potential to be developed across the load LD₁ which is different to the potential V₁ provided from the source 20. On account of the switch-mode nature of the SMPS 700, regulation of the voltage V₂ occurs in a way which results in less energy dissipation in comparison to using a simple conventional analogue resistive regulator.

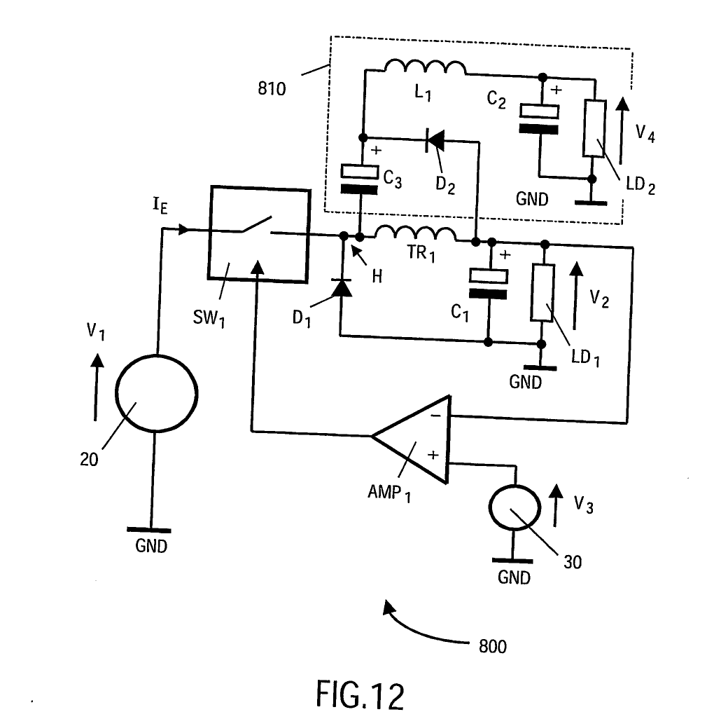

The inventor has appreciated that the SMPS 700 is also capable of being provided with an additional output derived by voltage multiplication according to the invention wherein, by virtue of being directly derived from the inductor TR₁ and its associated components such as the control amplifier AMP₁, the additional output is susceptible to being accurately regulated by the control amplifier AMP₁. Thus, referring to FIG. 12, there is shown a buck-type switch mode power supply apparatus (SMPS) according to the invention indicated by 800. The SMPS 800 includes components of the SMPS 700 illustrated in FIG. 11 together with additional voltage multiplier components included within dotted lines 810 in FIG. 12. The additional components include the capacitor C₃, the diode D₂, an inductor L₁ and the capacitor C₂. A negative electrode of the electrolytic capacitor C₃ is connected to a cathode electrode of the diode D₁ and to a first terminal of the inductor TR₁ as shown. Moreover, a positive electrode of the capacitor C₃ is coupled to a cathode electrode of the diode D₂ and to a first terminal of the inductor L₁. Furthermore, an anode electrode of the diode D₂ is coupled to the load LD₁ and the capacitor C₁ as shown. Lastly, a second terminal of the inductor L₁ is coupled to a positive electrode of the capacitor C₂ and to the load LD₂; a negative electrode of the capacitor C₂ and the load LD₂ are also connected to the ground potential GND.

In operation, the switching device SW₁ of the SMPS 800, under control of the amplifier AMP₁, periodically interrupts a current I_{E} flowing through the device SW₁ causing terminal H at the cathode electrode of the diode D₁ to momentarily switch to a potential of −V_{D1} relative to ground potential GND as a magnetic field established by the current I_{E} in the inductor TR₁ reduces. As the potential V₂ established by the SMPS 800 across the capacitor C₁ is not capable of changing instantaneously, a potential V₂+V_{D1} is developed periodically across the inductor TR₁ resulting in a voltage difference of a magnitude of V₂ being developed across the capacitor C₃. The inductor L₁ is arranged to present significant impedance at the switching frequency of the device SW₁, thereby, in combination with capacitor C₂, forming a low pass filter to attenuate ripple arising at the positive electrode of the capacitor C₂ and to prevent appearance of this ripple across the load LD₂. With regard to quasi-static conditions, a substantially negligible average voltage drop occurs across the inductor TR₁ and hence the negative electrode of the capacitor C₃ is, on average, at a potential of V₂ relative to the ground potential GND. Consequently, the output potential V₄ developed across the load LD₂ is substantially 2×V₂. On account of the control amplifier AMP₁ regulating the potential V₂ developed across the load LD₁ with respect to the reference potential V₃, the potential V₄ developed across the load LD₂ is also correspondingly substantially regulated in respect of the reference potential V₃.

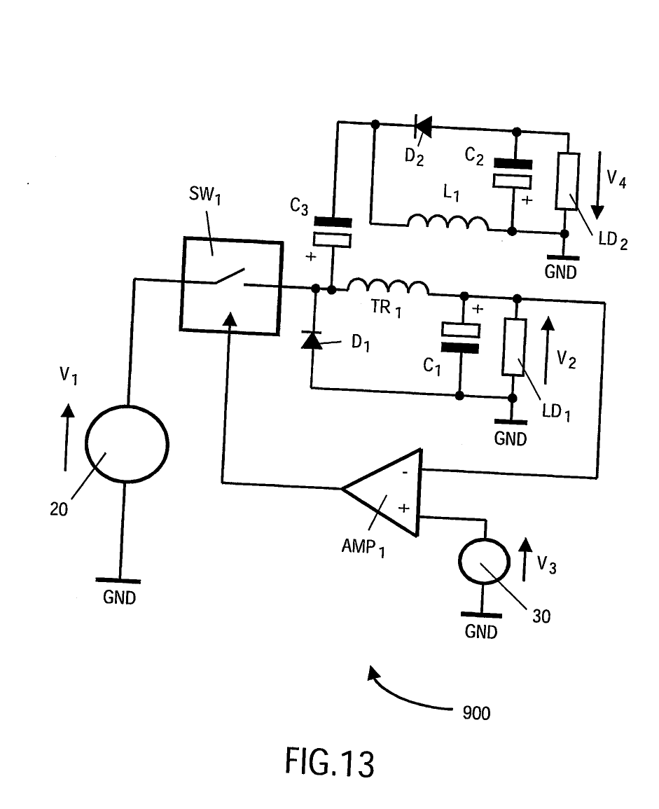

It will be appreciated that components forming the voltage multiplier of the SMPS 800 are susceptible to rearrangement to provide a buck-type switch mode power supply apparatus (SMPS) capable of outputting matched positive and negative potentials; such a rearranged SMPS is illustrated in FIG. 13 and indicated therein generally by 900. The SMPS 900 is similar to the SMPS 700 except that, in the SMPS 900, a voltage multiplier is implemented with the positive electrode of the capacitor C₃ connected to the cathode electrode of the diode D₁, to an electrode of the inductor TR₁ and to a power electrode of the device SW₁ as illustrated. A negative electrode of the capacitor C₃ is coupled to a cathode electrode of the diode D₂ and to a first terminal of the inductor L₁. A second terminal of the inductor L₁ and a positive electrode of the capacitor C₂ are coupled to the ground potential GND. Moreover, an anode electrode of the diode D₂ is coupled to a negative electrode of the capacitor C₂. The load LD₂ is connected across the electrodes of the capacitor C₂ as shown. Thus, the SMPS 900 is topologically configured as illustrated in FIG. 13.

The SMPS 900 is operable to generate a negative voltage V₄ which is of similar magnitude to the voltage V₂ and substantially tracks therewith. Hence, the SMPS 900 is capable of providing balanced symmetrical positive and negative supplies which are, for example, especially convenient for energizing analogue electronic circuits including components such as operational amplifiers and audio amplifiers arranged to operate around the ground potential GND.

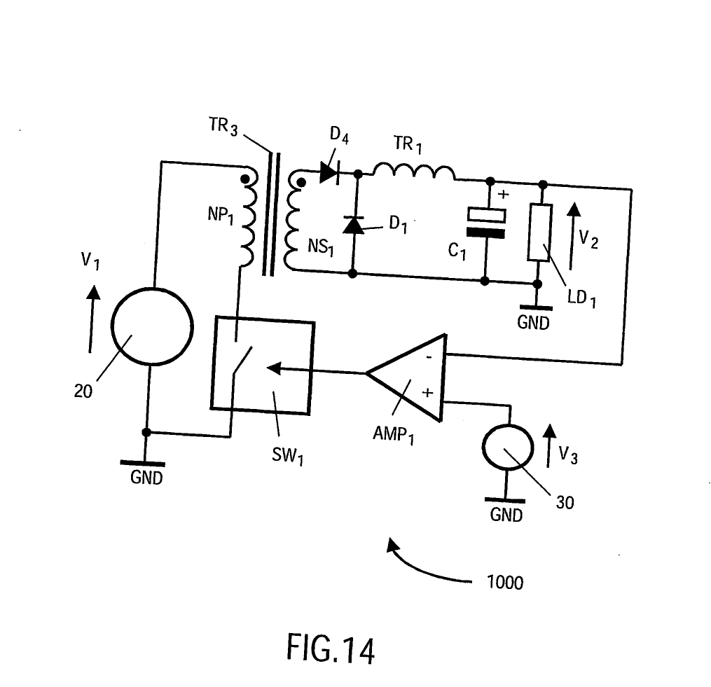

The inventor's foregoing approach to providing one or more additional outputs to SMPSs by using directly coupled voltage multiplying circuits is also applicable to forward-type converter switch mode power supplies apparatus (SMPSs). Referring to FIG. 14, there is shown a contemporary forward-type SMPS indicated generally by 1000. The SMPS 1000 includes the source 20 for providing a supply potential V₁, the transformer TR₃, the switching device SW₁, the diodes D₁, D₂, the inductor TR₁, the capacitor C₁, the control amplifier AMP₁ and the reference voltage source 30 for providing the reference voltage V₃.

Topological interconnection of components within the SMPS 1000 is as illustrated FIG. 14 and will herewith be described for completeness. First and second terminals of the source 20 for providing the potential V₁ are connected to a first terminal of the primary winding NP₁ of the transformer TR₃ and to the ground potential GND respectively. First and second power terminals of the switching device SW₁ are coupled to a second terminal of the primary winding NP₁ and to the ground potential GND respectively. A first terminal of the secondary winding NS₁ together with an anode electrode of the diode D₁ and a negative electrode of the electrolytic capacitor C₁ are coupled to the ground potential GND. A second terminal of the secondary winding NS₂ is connected to an anode electrode of the diode D₄. Cathode electrodes of the diodes D₁, D₄ are connected together and to a first terminal of the inductor TR₁. A second terminal of the inductor TR₁ is connected to a positive electrode of the capacitor C₁. Moreover, the load LD₁ is coupled across the capacitor C₁. The positive electrode of the capacitor C₁ is coupled to the inverting input (−) of the amplifier AMP₁. Moreover, The reference source 30 is connected between the ground potential GND 20 and the non-inverting input (+) of the amplifier AMP₁ to provide a reference voltage V₃ thereto. Furthermore, a PWM and/or pulse repetition frequency adjustable output from the amplifier AMP₁ is connected to a switching input of the switching device SW₁. The inductor TR₁ is not magnetically coupled to the core of the transformer TR₃.

In operation, the device SW₁ periodically interrupts current flow through the primary winding NP₁. At each interruption, a magnetic field established within the core of the transformer TR₃ prior to the interruption collapses causing a voltage to be induced across the secondary winding NS₁. The induced voltage at the secondary winding causes a secondary current to flow through the inductor TR₁ and subsequently to the capacitor C₁ and its associated load LD₁. The diode D₁ is operable to prevent the terminal of the inductor TR₁ connected to the cathode electrode of the diode D₄ falling by more than V_{D1} below the ground potential GND; as elucidated in the foregoing, V_{D1} is a forward conduction voltage drop arising across the diode D₁. The inductor TR₁ in combination with the capacitor C₁ and the diode D₁ are capable of effectively filtering, namely attenuating, ripple in the voltage V₂ at the switching frequency of the device SW₁. The control amplifier AMP₁ is operable to receive the potential V₂ at its inverting input and adjust its switching output to the switching input of the device SW₁ so as to try to match the potential V₂ to the potential V₃ and thereby regulate the potential V₂.

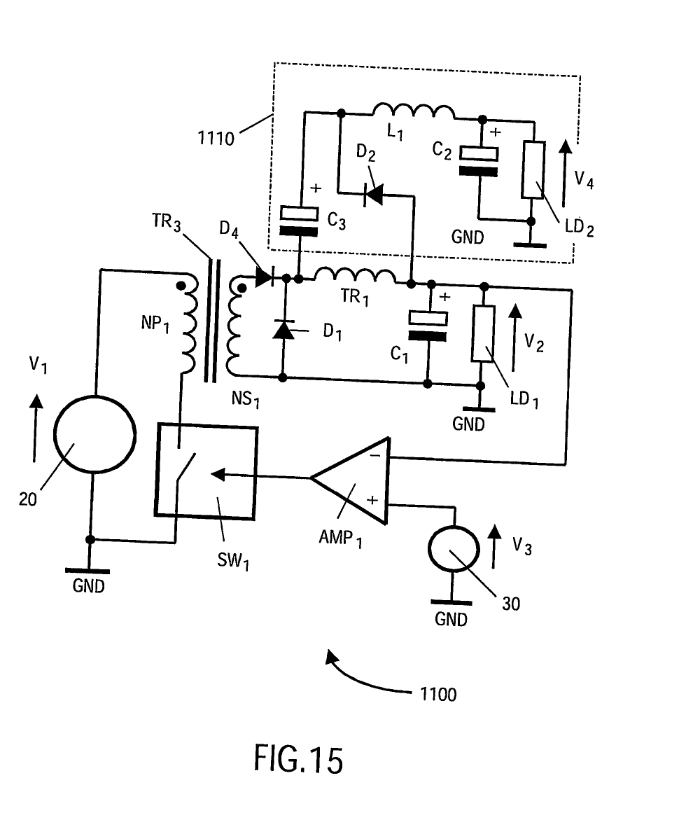

The inventor has appreciated that the forward-type converter SMPS 1000 of FIG. 14 is susceptible to be modified according to the invention to provide an additional output providing a potential substantially twice that developed across the load LD₁ in operation. Referring to FIG. 15, there is shown a forward-type converter SMPS indicated generally by 1100. The SMPS 1100 is similar to the SMPS 1000 except that the SMPS 1100 additionally includes a voltage multiplier shown within dashed lines 1110.

The voltage multiplier includes the electrolytic capacitors C₂, C₃, the inductor L₁ and the diode D₂ connected topologically as shown. The capacitor C₃ is connected at its negative electrode to the cathode electrodes of the diodes D₁, D₄. An anode electrode of the diode D₂ is coupled to the positive electrode of the capacitor C₁. Moreover, a cathode electrode of the diode D₂ is connected to a positive electrode of the capacitor C₃ and also to a first terminal of the inductor L₁. Furthermore, a second terminal of the inductor L₁ is coupled to a positive electrode of the capacitor C₂. Additionally, a negative electrode of the capacitor C₂ is connected to the ground potential GND, and the load LD₂ is connected across the electrodes of the capacitor C₂.

In operation, the switching device SW₁ momentary interrupts the current flowing through the primary winding NP₁ of the transformer TR₃ which causes the cathode electrode of the diode D₁ to momentarily assume a potential of −VD₁ relative to the ground potential GND. As the potential of V₂ developed across the capacitor C₁ is unable to change instantaneously, a peak potential of V₂+V_{D1} is periodically generated across the inductor TR₁. A combination of the diode D₂ and the capacitor C₃ is capable of charging the capacitor C₃ to this peak potential less a forward conduction voltage drop across the diode D₂, thereby charging the capacitor C₃ to a potential of V₂ thereacross. A potential thereby developed across the capacitor C₃ is equivalent to the potential V₂. In quasi-static conditions, an average voltage drop arising across the inductor TR₁ is substantially negligible resulting in the positive electrode of the capacitor C₃ assuming an average potential of 2×V₂ above the ground potential GND. The inductor L₁ and its associated capacitor C₂ are operable to form a low pass filter for attenuating high frequency ripple at the positive electrode of the capacitor C₃ at a switching frequency of the device SW₁.

Thus, the SMPS 1100 is operable to generate positive output potentials of V₂, V₄ relative to the ground potential GND across the loads LD₁, LD₂ respectively where V₄=2×V₂. Both the potentials V₂, V₄ mutually track to the reference potential V₃.

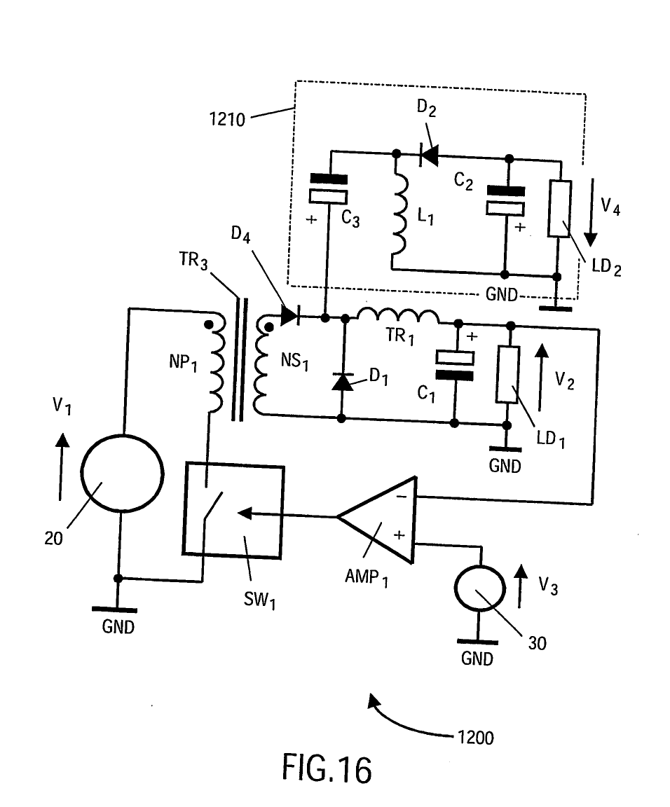

The SMPS 1100 is capable of being topologically reconfigured to provide balanced tracking negative and positive potentials. Such a modified SMPS is illustrated in FIG. 16 wherein a forward-type converter switch mode power supply (SMPS) providing balanced positive and negative outputs is indicated generally by 1200. The SMPS 1200 is similar to the SMPS 1000 expect that the SMPS 1200 includes a voltage multiplier shown within dashed lines 1210. The multiplier includes the capacitors C₂, C₃, the inductor L₁ and the diode D₂ connected together as shown. Namely, a positive electrode of the capacitor C₃ is connected to a cathode electrode of the diode D₄. Moreover, a first terminal of the inductor L₁ and a positive electrode of the capacitor C₂ are coupled to the ground potential GND. Furthermore, a negative electrode of the capacitor C₃ is connected to a second terminal of the inductor L₁ and to a cathode electrode of the diode D₃; an anode electrode of the diode D₂ is connected to a negative electrode of the capacitor C₂, the load LD₂ being connected across the electrodes of the capacitor C₂.

In the SMPSs 200, 300, 400, 500, 600, 800, 900, 1100, 1200, it will be appreciated that the choice of component values will depend upon a switching frequency at which these SMPSs function. The switching device SW1 preferably switches in a frequency range of 1 kHz to 500 kHz, although a switching frequency in a range of 10 kHz to 150 kHz is more preferred. Moreover, the choice of components will also depend upon an amount of power the SMPSs 200, 300, 400, 500, 600, 800, 900, 1100, 1200 are required to deliver. In many applications, the electrolytic capacitors of these SMPSs will each have a capacitance in a range of 1 μF to 10,000 μF. Moreover, the inductors will each have an inductance in a range of 500 nH to 1 Henry, more preferably in a range of 10 μH to 100 mH. The diodes D₁, D₂, D₃, D₄, D₅ are preferably fast recovery Silicon diodes, although Schottky and/or Germanium diodes can be used on account of their lower forward conduction voltage drop. Moreover, the diodes D₁ to D₅ are preferably matched and mounted in a substantially isothermal environment to provide enhanced tracking accuracy. The switching device SW₁ preferably includes at least one of a bipolar transistor (BJT), a field effect transistor (FET), a metal oxide semiconductor field effect transistor (MOSFET), a silicon control rectifier (SCR), a triac, a thermionic valve or any other type of semiconductor or thermionic device capable of rapidly modulating a current flow therethrough. If required, the control amplifier AMP₁ and the switching device SW₁ can be implemented in combination as an integrated circuit.

It will be appreciated that the SMPSs 200, 300, 400, 500, 600, 800, 900, 1100, 1200 can be modified to include a plurality of additional outputs generated using voltage multipliers as described in the foregoing, for example more than two additional outputs.

It will be appreciated that modifications can be made to SMPSs according to invention described in the foregoing without departing from the scope of the invention. For example, the invention is also applicable to contemporary resonant-type converter switch mode power supplies, for example contemporary LLC converters. Moreover, the invention is also susceptible to being applied to one or more of chuck-type converter switch mode power supplies, half-bridge-type switch mode power supplies, full-bridge-type switch mode power supplies, a sepic-type converter switch mode power supplies.

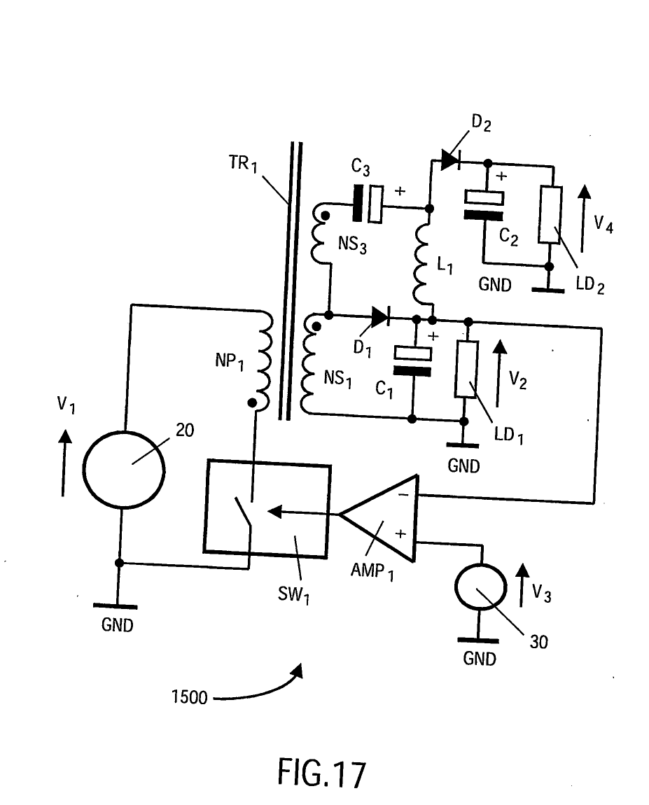

Although SMPSs according to the invention described in the foregoing are capable of providing additional output voltages at integer multiples of a main regulated voltage, namely the potential V₂, it will be appreciated that non-integer multiples can be generated by offsetting voltages used to generate the additional outputs. For example, the SMPS 200 in FIG. 4 can be modified to provide a flyback-type SMPS as illustrated in FIG. 17 and indicated therein by 1500. The SMPS 1500 is similar to the SMPS 200 except for the transformer TR₁ having two secondary windings NS₁ and NS₃ where the winding NS₃ has a non-integer multiple of turns in relation to the winding NS₁. Moreover, the negative electrode of the capacitor C₃ is connected to a first terminal of the winding NS₃ instead of to the first winding NS₁ as before. A second terminal of the winding NS₃ is connected to a first terminal of the winding NS₁ and coupled to an anode electrode of the diode D₁ as illustrated. The winding NS₁, NS₃ are connected in phase as shown and denoted by black dots adjacent to the windings NS₁, NS₃.

The SMPS 1500 is capable of providing an additional output voltage V₄ as defined by Equation 5 (Eq. 5):

$${V}_{4} = {V}_{2} ( 2 + \frac{{ns}_{3}}{{ns}_{1}} ) + {V}_{D 1} ( 1 + \frac{{ns}_{3}}{{ns}_{1}} ) - {V}_{D 2} \qquad Eq . 5$$

wherein
ns₁=number of turns on the secondary winding NS₁; and
ns₃=number of turns on the secondary winding NS₃.

Assuming that the diodes D1, D2 are substantially mutually matched, Equation 5 simplifies to yield Equation 6 (Eq. 6):

$${V}_{4} = {V}_{2} ( 2 + \frac{{ns}_{3}}{{ns}_{1}} ) + {V}_{DM} ( \frac{{ns}_{3}}{{ns}_{1}} ) \qquad Eq . 6$$

where V_{DM} is the mutually similar voltage drop across the diodes D₁, D₂. On account of employing an additional winding on the transformer TR₁, the SMPS 1500 is unable to regulate its additional output as well as the SMPS 200 but nevertheless represents an improvement on contemporary arrangements. If required, when the winding NS₃ is employed to achieve non-integer multiples, the diodes D₁, D₂, D₃ can be selected from a mixture of Silicon and Schottky diodes in order to enhance accuracy of the potential V₄. It will be appreciated that the non-integer voltage multiplication approach adopted for the SMPS 1500 is also applicable to other SMPSs according to the invention described in the foregoing.

It will be appreciated that SMPSs according to the invention described in the foregoing are susceptible to being used in a potentially wide range of applications, for example:
(a) in mobile telephones, for example for back-lighting for liquid crystal displays;
(b) in lap-top computers, in computer peripherals and other computer related devices:
(c) in electronic visual and audio consumer products such as televisions, high fidelity audio systems such as used in automotive environments where voltage multiplication is required from normal 12 volts automotive supply potentials to operate devices such as audio power amplifiers;
(d) in battery chargers; and
(e) in mains switch mode power supplies for interfacing to lower voltage solid-state electronic circuits.

It will be appreciated that, in embodiments of the invention described in the foregoing with reference to FIGS. 4 to 10, 12 to 15 to 17, that synchronous rectification, for example using field effect transistors (FETs), is feasible as an alternative to employing rectifier diodes. Such use of synchronous rectification is susceptible to reducing power losses arising in the embodiments when in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

1. A switch mode power supply apparatus (200; 300; 400; 500; 600; 800; 900; 1100; 1200; 1500) for receiving an input supply voltage (V₁) from an input supply source (20) and generating a corresponding main regulated output supply voltage (V₂) and at least one subsidiary output supply voltage (V₄), the apparatus including:
(a) inductive means (TR₁) having a terminal for providing a secondary output;
(b) switching means (SW₁) coupled between the input supply source (20) and the inductive means (TR₁) for applying current to the inductive means (TR₁) in a switched manner;
(c) main rectifying means (D₁, C₁) comprising a rectifier device (D₁) coupled to the terminal of the inductive means (TR₁) for receiving the secondary output and generating the main regulated output supply voltage (V₂) therefrom;
(d) feedback means (AMP₁) for comparing the main regulated output supply voltage (V₂) with at least one reference (30) to adjust operation of the switching means (SW₁) so as to maintain the main output supply voltage (V₂) in regulation; and
(e) subsidiary rectifying means (C₂, C₃, L₁, D₂) comprising a voltage multiplier comprising a capacitor (C₃) coupled to the terminal of the inductive means (Tr₁) so as to receive signals therefrom which are subject to regulation by the feedback means (AMP₁) for generating said at least one subsidiary output voltage (V₄).

2. An apparatus according to claim 1, wherein the main rectifying means (D₁, C₁) and the subsidiary rectifying means (C₂, C₃, L₁, D₂) are mutually connected in such a manner that voltage drops in the respective rectifying means (D₁, D₂) are arranged to at least partially cancel so as to render said at least one subsidiary output supply voltage (V₄) less dependent upon said voltage drops.

3. An apparatus according to claim 1, wherein diodes included within the main rectifiying means (D₁, C₁) and the subsidiary rectifying means (C₂, C₃, L₁, D₂) comprise switching devices functioning as synchronous rectifiers.

4. An apparatus according to claim 1, wherein the main output supply voltage (V₂) and the at least one subsidiary supply voltage (V₄) are arranged to be substantially symmetrical positive and negative voltages.

5. An apparatus according to claim 1, wherein the subsidiary rectifying means (C₂, C₃, L₁, D₂) further comprises an inductor (L₁), and a rectifier diode (D₂).

6. An apparatus according to claim 5, wherein the inductor (L₁) is not magnetically coupled to the inductive means (TR₁).

7. An apparatus according to claim 1, wherein the subsidiary rectifying means (C₂, C₃, L₁, D₂) includes a low pass filter preceding its at least one subsidiary output supply voltage (V₄) for attenuating switching ripple of said at least one subsidiary output voltage (V₄).

8. An apparatus according to claim 1, wherein the capacitor (C₃) is coupled to the terminal via a winding of the inductive means (TR₁).
